(19) United States
(12) Patent Application Publication
(10) Pub. No.: US 2005/0096032 A1
(43) Pub. Date: May 5, 2005

(54) Method and apparatus for providing dynamically configurable feature packages to users of a wireless network

(76) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114, US

(21) Appl. No.: 10/700,962

(22) Filed: Oct. 31, 2003

(51) Int. Cl. H04M 11/00

(52) U.S. Cl. 455/422.1; 455/433; 455/432.1; 455/406

(57) ABSTRACT

A method and apparatus for providing dynamically configurable feature packages to users of a wireless network is provided. More particularly, the development includes implementing a system that allows users to select a predetermined number of available features for wireless connectivity. This selection process is controlled by the user without interaction of the wireless service provider, allows for real time changes to a feature package to which the user subscribes (preferably, without incurring further cost) and facilitates activation of a variety of billing alternatives such as flat rates, per use rates, package rates, pro-rated billing rates, etc.

### BACKGROUND OF THE INVENTION

This invention relates to a method and apparatus for providing dynamically configurable feature packages to users of a wireless network. More particularly, the development includes implementing a system that allows users to select a predetermined number of available features for wireless connectivity. This selection process is controlled by the user without interaction of the wireless service provider, allows for real time changes to a feature package to which the user subscribes (preferably, without incurring further cost) and facilitates activation of a variety of billing alternatives such as flat rates, per use rates, package rates, pro-rated billing rates, etc.

While the invention is particularly directed to selection of wireless network features, and will be thus described with specific reference thereto, it will be appreciated that the invention may have usefulness in other fields and applications. For example, the invention may be used in other applications where remote configuration of a system is desired.

By way of background, extensive service provider resources are typically required for mobile subscribers to add or delete features from calling plans and, consequently, alter monthly billing procedures. In this regard, it is common for service providers to employ customer service representatives for the benefit of its customers. These customer service representatives typically engage in manual order processing. In this regard, the customer service representatives may manually input billing system information so that different wireless features can be added or subtracted from customer accounts upon the request of the customers. Also, some type of interaction between the customer and the customer service representative is necessary. In this way, the current practices are costly and static by design—so changes are only implemented for selected circumstances and, then, only after significant delay and human interaction.

An additional disadvantage of the current practices is that the ability of a subscriber to modify its service package is limited to the business hours scheduled by the service provider for customer service.

Service providers, therefore, concentrate their attention and resources on fewer, more profitable features in order to justify the noted costs. As a result, possible revenue from convenient, but less significant, features is never realized.

Along these lines, these convenient, but less significant, features are not promoted by wireless service providers because these features do not usually justify the necessary advertising and customer service costs. Such features may include call forwarding, busy call forwarding, call waiting, voice mail, three-way calling, caller identification, detailed billing, or personalized ringing. Of course, this is only a sampling of features so other known features that may be available to users also fall within this category.

The present invention contemplates a new and improved method and apparatus for providing dynamically configurable feature packages to users of a wireless network that resolves the above-referenced difficulties and others.

### SUMMARY OF THE INVENTION

A method and apparatus for providing dynamically configurable feature packages to users of a wireless network are provided.

In one aspect of the invention, the system includes a subscriber database having stored therein subscriber information indicating whether the mobile station is operative to allow for dynamic configuration of features, a feature database having stored therein feature information, the feature information being comprised of first feature information representing all available features and second feature information representing activated features for the mobile station, a billing database having stored therein billing information corresponding to the second feature information and a mobile switching center having a feature selection module operative to receive a request from the mobile station to dynamically configure the features by modifying the second feature information, access the subscriber database to verify that the mobile station is operative to allow the modification, recognize the modification and communicate the modification to the feature database and the billing database.

In another aspect of the invention, the feature selection module is further operative to receive a request from the mobile station to alter the billing information, access the subscriber database to verify that the mobile station is operative to allow the alteration, recognize the alteration and communicate the alteration to the billing database.

In another aspect of the invention, the feature selection module is further operative to download a menu display to the mobile station.

In another aspect of the invention, the menu display is generated based on information in the feature database.

In another aspect of the invention, the menu display is generated based on information from the billing database.

In another aspect of the invention, the method comprising storing subscriber information indicating whether the mobile station is operative to allow for the dynamic configuration of features, storing feature information comprised of first feature information representing all available features and second feature information representing activated features for the mobile station, storing billing information corresponding to the second feature information, receiving a request from the mobile station to dynamically configure the features by modifying the second feature information, accessing the subscriber database to verify that the mobile station is operative to allow the modification, recognizing the modification and communicating the modification to the feature database and the billing database.

In another aspect of the invention, the method further comprises receiving a request from the mobile station to alter the billing information, accessing the subscriber database to verify that the mobile station is operative to allow the alteration, recognizing the alteration and communicating the alteration to the billing database.

In another aspect of the invention, the method further comprises downloading a menu display to the mobile station.

In another aspect of the invention, the menu display is generated based on information in the feature database.

In another aspect of the invention, the menu is generated based on information from the billing database.

In another aspect of the invention, the system comprises first means for storing subscriber information indicating whether the mobile station is operative to allow for the dynamic configuration of features, second means for storing feature information comprised of first feature information representing all available features and second feature information representing activated features for the mobile station, third means for storing billing information corresponding to the second feature information, means for receiving a request from the mobile station to dynamically configure the features by modifying the second feature information, means for accessing the first storing means to verify that the mobile station is operative to allow the modification, means for recognizing the modification and means for communicating the modification to the second storing means and the third storing means.

In another aspect of the invention, the system further comprises means for receiving a request from the mobile station to alter the billing information, means for accessing the second storing means to verify that the mobile station is operative to allow the alteration, recognizing the alteration and communicating the alteration to the third storing means.

In another aspect of the invention, the system further comprises means for downloading a menu display to the mobile station.

In another aspect of the invention, the menu display is generated based on information in the second storing means.

In another aspect of the invention, the menu is generated based on information from the third storing means.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a graphic illustration of a network into which the present invention may be incorporated;

FIG. 2 is a graphic illustration of a database according to the present invention;

FIG. 3 is a graphic illustration of a database according to the present invention;

FIG. 4 is a graphic illustration of a database according to the present invention;

FIG. 5 is a block diagram of a mobile switching center according to the present invention;

FIG. 6 is a flow chart illustrating a method according to the present invention;

FIG. 7 is a flow chart illustrating a method according to the present invention; and,

FIG. 8 is a representative illustration of an example a feature menu message display provided to a user according to the present invention.

### DETAILED DESCRIPTION OF THE PREFERRED EMBODIMENTS

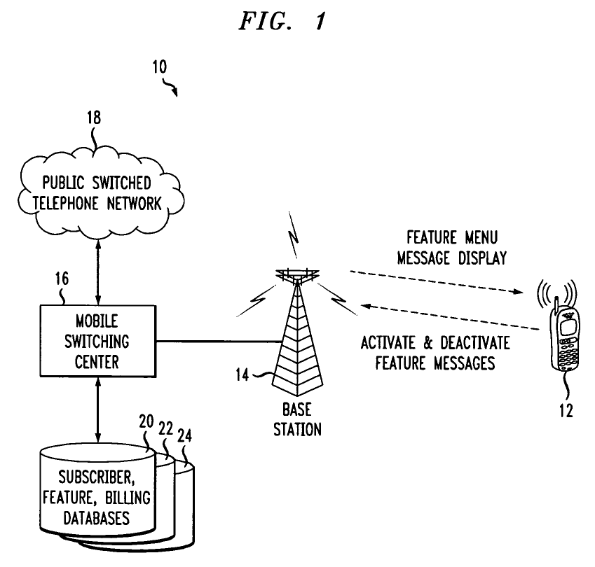

Referring now to the drawings wherein the showings are for purposes of illustrating the preferred embodiments of the invention only and not for purposes of limiting same, FIG. 1 provides a view of an exemplary network 10 into which the present invention may be incorporated. Of course, the network 10 may take a variety of forms to implement the invention. As shown, the network 10 is operative to communicate with a mobile station 12. It should be appreciated that the mobile station 12 may take the form of a wireless phone, a personal digital assistant (PDA) or any like device.

According to the present invention, the mobile station 12 communicates with the network 10 to activate and deactivate wireless features, such as those less significant wireless features contemplated above. As noted above, such features may include call forwarding, busy call forwarding, call waiting, voice mail, three-way calling, caller identification, detailed billing, or personalized ringing. A variety of other features that may be available to users also fall within this category of less significant features.

Of course, the invention is not limited to activation and deactivation of only less significant features, it encompasses a system and method to accommodate activation and deactivation of any features that may be available to wireless users. The implementation of the invention as being primarily directed toward the less significant wireless features results only from a desire to identify an area of need in the wireless industry but should not be construed as limiting the scope of the invention.

As will be discussed in more detail below, activation and deactivation of features are accomplished using the present invention through the provision of a feature menu message display by the network 10 to the mobile station 12. Based on the menu display, a user of the mobile station 12 is capable of sending activate and deactivate feature messages back to the network 10 to configure or reconfigure a feature package to which the user subscribes. It should be understood that the user may manipulate the menu to send the messages in a variety of manners. For example, hard or soft keys may be used, as well as voice recognition commands. The network, e.g. mobile switching station (NSC) 16, is operative to implement the changes to the feature package and, optionally, adjust any necessary billing information.

More specifically, the mobile station 12 communicates with a base station 14 which is connected to a mobile switching center (MSC) 16. The mobile switching center 16 may be connected to any of a variety of possible networks, such as the public switched telephone network (PSTN) 18 (as shown). Mobile switching center (MSC) 16 is also operative to access a variety of network databases, including the subscriber database 20, feature database 22 and billing database 24. While a mobile switching center (MSC) is described in this example embodiment in view of the current generation of wireless technology that is readily available, the invention is not so limited. The invention may be applied or incorporated into a component(s) that provides the primary switching capability for the system, no matter the generation of technology. Moreover, the invention may be implemented in other network components (non-MSC or non-switching) provided that appropriate mapping information is used.

As to the databases 20, 22, and 24, these components may be implemented in a variety of manners. For example, such databases may be implemented as unique tables or fields within a larger database, such as a mobile subscriber database. Alternatively, the databases may be implemented as separate databases. In any of these scenarios, or others, those of skill in the art will understand the manner in which the databases will be most efficiently deployed upon a reading and understanding of the present invention.

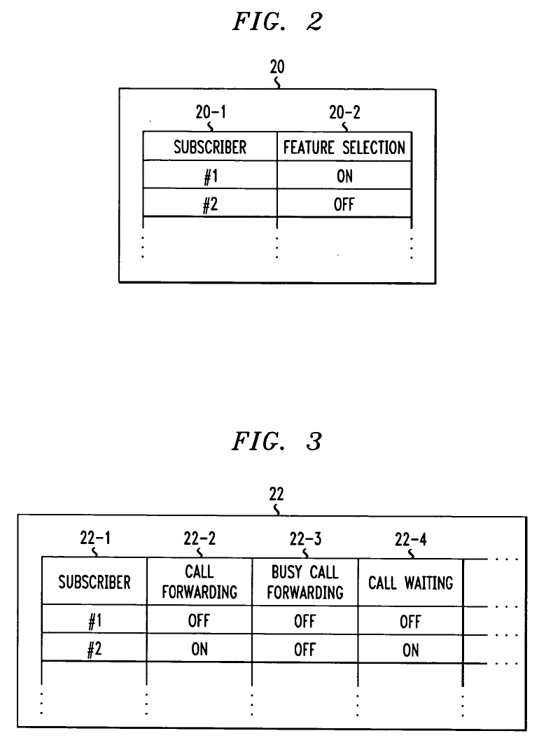

For simplicity of explanation, databases 20, 22 and 24 are illustrated in FIGS. 2, 3, and 4. With respect to FIG. 2, database 20 is shown as including subscriber identification information 20-1 and feature selection information 20-2. As shown, subscriber #1 subscribes to the feature selection feature of the present invention so the feature selection data column indicates that this feature is “ON”. Conversely, subscriber #2 is illustrated as not subscribing to the feature selection feature. Therefore, the feature selection data is “OFF”, as shown. It should be appreciated that the subscriber information 20-1 may take a variety of forms that are well known to those skilled in the art, such as subscriber identification numbers. Likewise, the indication of “ON” or “OFF” in the feature selection column 20-2 may take a variety of forms including flags that are set (e.g. to “1”) or reset (e.g. to “0”).

Referring now to FIG. 3, feature database 22 is illustrated. As shown, the feature database 22 includes subscriber information 22-1 as well as data columns indicating whether any one subscriber subscribes to particular features, such as call forwarding 22-2, busy call forwarding 22-3, call waiting 22-4, . . . . etc. It should be understood that a variety of other features, such as those listed above and others, may be listed within the database 22; however, only three are illustrated for ease of explanation. As can be seen, the database 22 indicates the features to which a particular subscriber subscribes. For example, as shown, subscriber #1 does not subscribe to any of the listed features. Subscriber #2, however, subscribes to the call forwarding and call waiting features. In this way, the database has stored therein two types of data—information representing all available features and information representing only activated features. Like the data stored in the database 20, the data, e.g., subscriber information and feature data, may take a variety of forms that are well known to those skilled in the art.

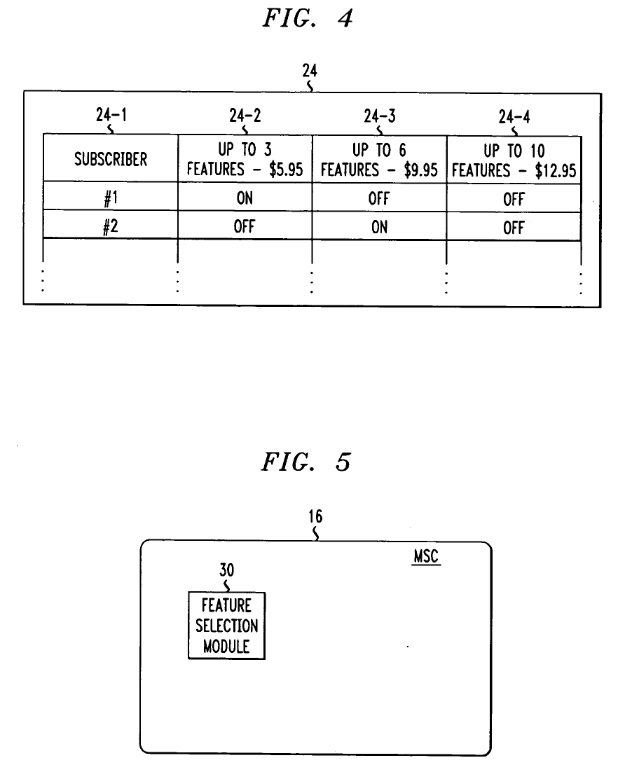

Referring now to FIG. 4, billing database 24 is illustrated. This database contains subscriber information 24-1 and billing alternative information 24-2, 24-3, and 24-4. It should be appreciated that other billing alternatives may also be included; however, only three are shown for ease of explanation. Subscriber #1 is illustrated as subscribing to a billing package of up to three features for $5.95. While subscriber #2 uses billing package 24-3, i.e., up to six features for $9.95. Again, these billing packages are mere examples.

Referring now to FIG. 5, mobile switching center (MSC) 16 is shown in greater detail. It is to be appreciated that mobile switching center (MSC) 16 includes a variety of components to perform a variety of functions that are well known to those skilled in the art. For simplicity, these components are not shown in FIG. 5 nor are the functions described. However, modifications to the MSC 16 that are incorporated therein to implement the present invention are shown.

In this regard, a feature selection module 30 is incorporated into the mobile switching center (MSC) 16 to perform a variety of tasks to realize the provision of a dynamically configurable feature package for users of a wireless network. The feature selection module 30 may be implemented in a variety of manners that will be appreciated by those of skill in the art upon a reading and understanding of the present invention. For example, the module may be realized using software code and appropriate hardware support. In whatever form, the feature selection module 30 will be operative to achieve the objectives of the invention.

Specifically, the feature selection module 30 is operative to receive a request from the mobile station 12 to dynamically configure (or reconfigure) the feature package to which the mobile station 12 subscribes. To do this, the features that are activated for the mobile station 12 can be modified. In this regard, active features can be deactivated and inactive features can be activated. In addition, billing information (e.g., that stored in database 24) can be modified by the user. It should be appreciated that the network, or service provider, can then use the billing information to bill the subscriber in various manners.

Before facilitating activation and deactivation of features (or billing information alterations), the feature selection module 30 accesses the subscriber database 20 to verify that the mobile station 12 is operative to allow such modification. Upon such verification, the feature selection module 30 downloads a menu (as will be described in connection with FIG. 8) to the mobile station 12 to allow the user of mobile station 12 to activate and deactivate features according to a selected billing package (or alter the billing package). The wireless messages generated as a result of the user manipulation of the downloaded menu are recognized as modifications by the feature selection module 30. The feature selection module 30 then communicates the modifications to the feature database 22 and/or the billing database 24.

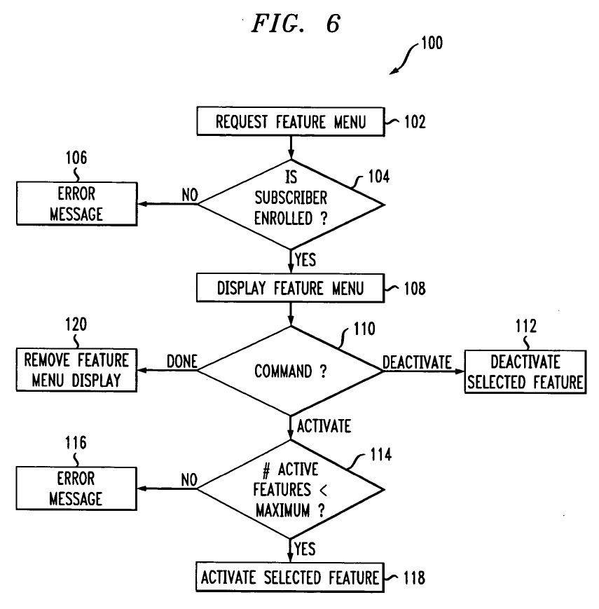

Referring now to FIG. 6, a method 100 illustrating the present invention is shown. This method may be implemented in a variety of manners but, in some embodiments, will take the form of a routine for which feature selection module 30 has primary responsibility for running. According to this method, mobile station 12 requests the feature menu (step 102) which is received by the feature selection module 30. The feature selection module 30 then determines if the mobile station user, or subscriber, is enrolled in a program to dynamically configure its feature package by accessing database 20 (step 104). If the user of mobile station 12 is not an enrolled subscriber, an error message is generated and sent to the user (step 106). However, if the user of mobile station 12 is an enrolled subscriber in the dynamically configurable feature package program, the feature selection module 30 downloads a feature menu to the mobile station 12, which is then displayed thereon (step 108). It is to be appreciated that the feature selection module 30 accesses the feature database 22 to determine the contents of the menu that is downloaded to the mobile station 12. Typically, this will include information on all available features and information on activated features. The feature selection module 30 may also access the billing database 24 where the billing information is supplied to the user for review or alteration. Once the downloaded menu is displayed to the user, the user determines the command that it wishes to implement (step 110). For example, the user may decide to deactivate a selected feature (step 112). In this case, the feature database 22 will be modified. As an alternative, the user may choose to activate a feature, in which case the feature selection module 30 determines if the number of active features is less than the maximum number of features allowed based on the user feature package (step 114). If the number of active features is not less than a maximum, an error message is generated and sent to the user (step 116). If, however, the number of active features is less than a maximum threshold, the newly selected feature is activated by modifying the feature database 22 (step 118). Of course, the billing database 24 is also updated when necessary so that proper billing may be accomplished.

Upon the determination by the user that activation and deactivation of features is complete, the user manipulates the menu to indicate to the feature selection module 30 that the configuration is complete and the feature menu display is removed (step 120).

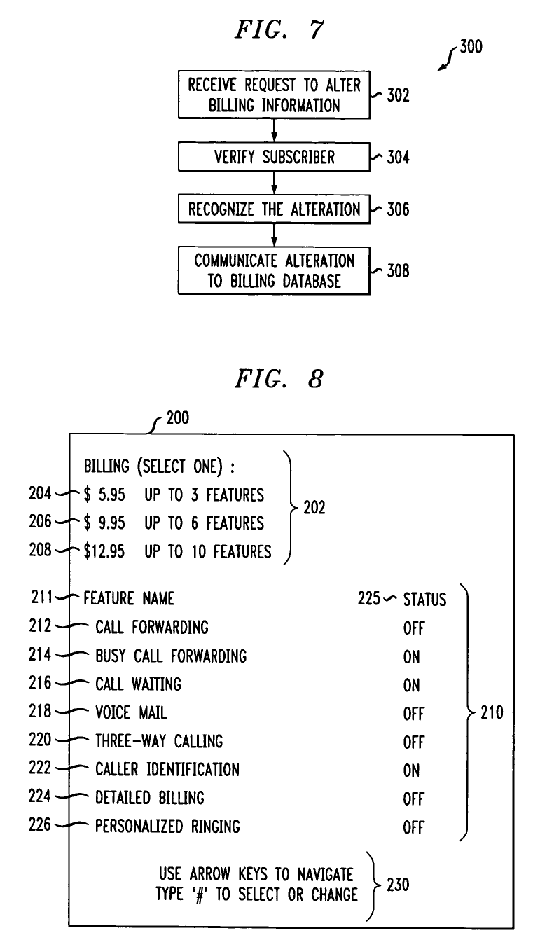

Referring now to FIG. 7, it is to be appreciated that the system is similarly operative to allow dynamic alteration of the billing packages that may be available to users, illustratively shown by a method 300. In this regard, the feature selection module 30 is further operative receive a request from the mobile station to alter the billing information (step 302), access the subscriber database to verify that the mobile station is operative to allow the alteration (step 304), recognize the alteration (step 306) and communicate the alteration to the billing database (step 308). This billing information is then used by various components in the network to assure that the subscriber is properly billed.

Referring now to FIG. 8, an example menu 200 is shown. The menu includes a billing selection portion 202 showing billing selection choices 204, 206 and 208. A feature selection portion 210 is shown that includes information representing all available features—such as call forwarding 212, busy call forwarding 214, call waiting 216, voice mail 218, three-way calling 220, caller identification 222, detailed billing 224, and personalized ringing 226. Also contained within the feature selection portion 210 is a status indicator 225. As illustrated, the status of each of the features is shown as being ON or OFF. Accordingly, within the listing of all available features in the feature selection portion 210, there is a subset of activated features. In this example, these activated features are busy call forwarding 214, call waiting 216 and caller identification 222. A command menu 230 is also illustrated in the sample menu 200.

In operation, the subscriber may initiate the feature selection package according to the present invention by pressing a hard key or activating a soft key on the mobile station, e.g., wireless phone, or by using other methods such as voice recognition. As a result, the mobile station 12 sends a request to the network, e.g. MSC 16, and the network responds by downloading a menu (such as that shown in FIG. 4) to the mobile station—provided, of course, that the network determines, as detailed above, that the subscriber is enrolled in the program. From the menu, the subscriber may modify a previously selected billing package by manipulating the billing package selections 204, 206 or 208 by, for example, using the arrow keys and the “#” sign (as indicated in command menu 230). The user's manipulation of the menu results in information being conveyed to the network so that appropriate action, as described herein, is then taken. It should be appreciated that other billing alternatives could be made available to the subscribers such as flat rates, per use rates, package rates, pro-rated billing rates, etc. It should be further appreciated that a change in billing selection may require prorating of the actual amounts billed to the subscriber. However, service providers may address these situations in various manners.

Whether or not the subscriber alters the billing status, the subscriber may then select the appropriate number of features from the feature selection portion or change the selected features. As shown, arrow keys are used to navigate and the “#” keys are used to select or change. This functionality may be implemented in a variety of manners. However, all such manners preferably allow for dynamic configuration of network features by a subscriber without interaction of a wireless service provider. The implementation should also allow for alterations of the features at any time and should facilitate a plurality of billing alternatives. In any event, the user's manipulation of the menu results in information (such as activate and deactivate feature messages) being conveyed to the network so that appropriate action, as described herein, is then taken.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A system for facilitating dynamic configuration of features provided to a mobile station within a network, the system comprising:
a subscriber database having stored therein subscriber information indicating whether the mobile station is operative to allow for the dynamic configuration of features;
a feature database having stored therein feature information, the feature information being comprised of first feature information representing all available features and second feature information representing activated features for the mobile station;
a billing database having stored therein billing information corresponding to the second feature information; and,
a mobile switching center having a feature selection module operative to receive a request from the mobile station to dynamically configure the features by modifying the second feature information, access the subscriber database to verify that the mobile station is operative to allow the modification, recognize the modification and communicate the modification to the feature database and the billing database.

2. The system as set forth in claim 1 wherein the feature selection module is further operative to receive a request from the mobile station to alter the billing information, access the subscriber database to verify that the mobile station is operative to allow the alteration, recognize the alteration and communicate the alteration to the billing database.

3. The system as set forth in claim 1 wherein the feature selection module is further operative to download a menu display to the mobile station.

4. The system as set forth in claim 3 wherein the menu display is generated based on information in the feature database.

5. The system as set forth in claim 3 wherein the menu is generated based on information from the billing database.

6. A method for facilitating dynamic configuration of features provided to a mobile station within a network, the method comprising:
storing subscriber information indicating whether the mobile station is operative to allow for the dynamic configuration of features;
storing feature information comprised of first feature information representing all available features and second feature information representing activated features for the mobile station;
storing billing information corresponding to the second feature information;
receiving a request from the mobile station to dynamically configure the features by modifying the second feature information;
accessing the subscriber database to verify that the mobile station is operative to allow the modification;
recognizing the modification; and,
communicating the modification to the feature database and the billing database.

7. The method as set forth in claim 6 further comprising receiving a request from the mobile station to alter the billing information, accessing the subscriber database to verify that the mobile station is operative to allow the alteration, recognizing the alteration and communicating the alteration to the billing database.

8. The method as set forth in claim 6 further comprising downloading a menu display to the mobile station.

9. The method as set forth in claim 8 wherein the menu display is generated based on information in the feature database.

10. The method as set forth in claim 8 wherein the menu is generated based on information from the billing database.

11. A system for facilitating dynamic configuration of features provided to a mobile station within a network, the system comprising:
first means for storing subscriber information indicating whether the mobile station is operative to allow for the dynamic configuration of features;
second means for storing feature information comprised of first feature information representing all available features and second feature information representing activated features for the mobile station;
third means for storing billing information corresponding to the second feature information;
means for receiving a request from the mobile station to dynamically configure the features by modifying the second feature information;
means for accessing the first storing means to verify that the mobile station is operative to allow the modification;
means for recognizing the modification; and,
means for communicating the modification to the second storing means and the third storing means.

12. The system as set forth in claim 11 further comprising means for receiving a request from the mobile station to alter the billing information, means for accessing the second storing means to verify that the mobile station is operative to allow the alteration, recognizing the alteration and communicating the alteration to the third storing means.

13. The system as set forth in claim 11 further comprising means for downloading a menu display to the mobile station.

14. The system as set forth in claim 13 wherein the menu display is generated based on information in the second storing means.

15. The system as set forth in claim 13 wherein the menu is generated based on information from the third storing means.
